(19) United States
(12) Patent Application Publication
(10) Pub. No.: US 2010/0230044 A1
(43) Pub. Date: Sep. 16, 2010

(54) BUBBLELESS PACKAGING METHOD

(76) Inventors: Shih-Kang FAN, Hsinchu City (TW); Ching-Hsiang Hsu, Hsinchu City (TW); Cheng-Pu Chiu, Taipei County (TW); Chi-Neng Mo, Taoyuan County (TW); Mei-Tsao Chiang, Taoyuan County (TW)

Correspondence Address: Muncy, Geissler, Olds & Lowe, PLLC, 4000 Legato Road, Suite 310, FAIRFAX, VA, 22033, US

(21) Appl. No.: 12/403,023

(22) Filed: Mar. 12, 2009

(51) Int. Cl. B32B 37/00

(52) U.S. Cl. 156/272.6

(57) ABSTRACT

A bubbleless packaging method is provided. The method is applicable to package a display element. In the method, firstly, a first substrate and a first protective layer are provided. The first protective layer is formed on the first substrate. Then, a second substrate and a second protective layer are provided. The second protective layer is formed on the second substrate. Then, a plasma treatment is performed on surfaces of the first protective layer and the second protective layer. Then, the first substrate and the second substrate are dipped into a solution after the plasma treatment. Then, the first substrate and the second substrate are laminated in the solution, wherein the first protective layer faces the second protective layer. Finally, the first substrate and the second substrate are taken out from the solution.

### BACKGROUND OF THE INVENTION

1. Field of the Invention

The present invention relates to a packaging method, and more particularly to a bubbleless packaging method.

2. Related Art

A typical example of a display device is a liquid crystal display (LCD). The LCDs have advantages of power-saving, light weight, free of radiation, and portable, so the LCDs have gradually replaced the conventional display assemblies. Furthermore, thin film transistor liquid crystal displays (TFT-LCDs) have advantages of high resolution, high response speed, and high definition, and are applicable for animation displaying. Therefore, the TFT-LCDs have been widely applied in car navigation systems, notebook computers, video cameras and the like. In recent years, with the breakthrough in the development of the wide viewing angle technology, the LCDs are further applied in large-size televisions, which gradually replace the conventional CRT televisions.

Generally, an LCD panel mainly includes a color filter (CF) at a front end, a TFT panel at a rear end, and a liquid crystal (LC) layer for guiding lights sandwiched between two glass substrates.

In a conventional liquid crystal injection manner, the glass at the TFT end and the glass at the CF end are combined first. Then, an air in a sealed chamber is removed by evacuation. After that, the structure is dipped into a liquid crystal sink, and the liquid crystal is injected slowly through capillarity. Once the injection is completed, the liquid crystal injection hole is sealed.

Another manner for injecting the liquid crystal is an ODF method, which is applicable to the production of large-size panels. Firstly, a sealant dispensing process required for combining the TFT panel with the CF panel is performed on the CF panel. Then, a required amount of liquid crystals is dropped on the CF panel, and the lower substrate and the upper substrate are combined in a vacuum environment, and then the substrates are aligned and baked.

However, the above methods must be operated in a vacuum environment to avoid bubbles in the LC layer, so as to prevent defects in use. In addition, the production process of evacuation requires additional expensive instruments, which increases the manufacturing cost.

Furthermore, when the currently available LCD packaging technology is applied in the packaging for the current electronic paper industry, the packaging substances, e.g., water solution (water and particles), are still not applicable to the LCD technology, because the particles and water may not be distributed evenly due to different fluidities caused by the siphon effect.

### SUMMARY OF THE INVENTION

The present invention is directed to a packaging method, which is suitable for realizing a packing effect free of bubbles.

The present invention provides a bubbleless packaging method, which is applicable to package a display assembly. First, a first substrate and a first protective layer are provided. The first protective layer is formed on the first substrate, totally covers the first substrate, and has at least one concave pattern. Then, a second substrate and a second protective layer are provided. The second protective layer is formed on the second substrate. Then, a plasma treatment is performed on surfaces of the first protective layer and the second protective layer. Then, the first substrate and the second substrate are dipped in a water solution after the plasma treatment. A laminating process is performed on the first substrate and the second substrate in the water solution, and the first protective layer faces the second protective layer during the laminating process. Finally, the laminated first substrate and the second substrate are taken out from the solution.

In an embodiment of the present invention, the water solution is an optical-coupling liquid, the plasma is an oxygen plasma, the first substrate is an indium tin oxide (ITO) glass, the second substrate is an ITO glass, the display assembly is an electrophoretic display or a polarized display, the first protective layer is made of polydimethylsiloxane (PDMS) or a negative photoresist (SU8), the second protective layer is made of PDMS or a negative photoresist (SU8), and the laminated first protective layer and the second protective layer are used as a spacer for keeping a gap between the first substrate and the second substrate.

In an embodiment of the present invention, the method further includes adding an adhesive at a top of the concave pattern after the plasma treatment.

In an embodiment of the present invention, the method further includes adding a sealant around a joint between the first substrate and the second substrate after the laminating process.

The protective layers are made of the PDMS or the SU8, which is a hydrophobic high-molecular material. After the oxygen plasma treatment, a surface property of the protective layers is changed from hydrophobic to hydrophilic. Thus, the water solution automatically covers the surfaces of the protective layers, so as to remove the bubbles, thereby achieving the packaging effect free of bubbles.

### BRIEF DESCRIPTION OF THE DRAWINGS

The present invention will become more fully understood from the detailed description given herein below for illustration only, which thus is not limitative of the present invention, and wherein:

FIG. 1 is a schematic cross-sectional view of a display assembly according to the present invention; and

FIGS. 2A to 2G are schematic views of a packaging method of the display assembly shown in FIG. 1.

### DETAILED DESCRIPTION OF THE INVENTION

In order to make the aforementioned features and advantages of the present invention comprehensible, embodiments are described in detail below with reference to the accompanying drawings.

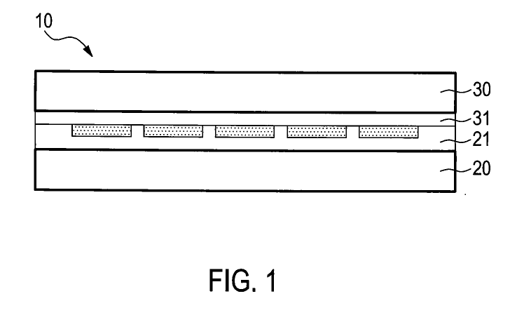

FIG. 1 is a schematic cross-sectional view of a display assembly according to the present invention. Referring to FIG. 1, a display assembly 10 includes a first substrate 20, a first protective layer 21, a second substrate 30, and a second protective layer 31.

The first protective layer 21 is formed on a surface of the first substrate 20, and totally covers the surface of the first substrate 20. Therefore, the first substrate is not exposed. In addition, the first protective layer 21 has at least one concave pattern. The first substrate 20 may be made of an ITO glass, and the first protective layer 21 is made of PDMS or a SU8.

The second protective layer 31 is formed on a surface of the second substrate 30. The second substrate 30 may be made of an ITO glass, and the second protective layer 31 is made of PDMS or a SU8.

Here, the first protective layer 21 and the second protective layer 31 are selected to be made of the PDMS in this embodiment. The PDMS contains siloxanyl, and thus has advantageous optical transparency, heat resistance, and mechanical properties. When being applied in packaging a display assembly, the PDMS may be used as a spacer for keeping a gap between the first substrate 20 and the second substrate 30.

In the above embodiment of the present invention, the display assembly may be an electrophoretic display or a polarized display.

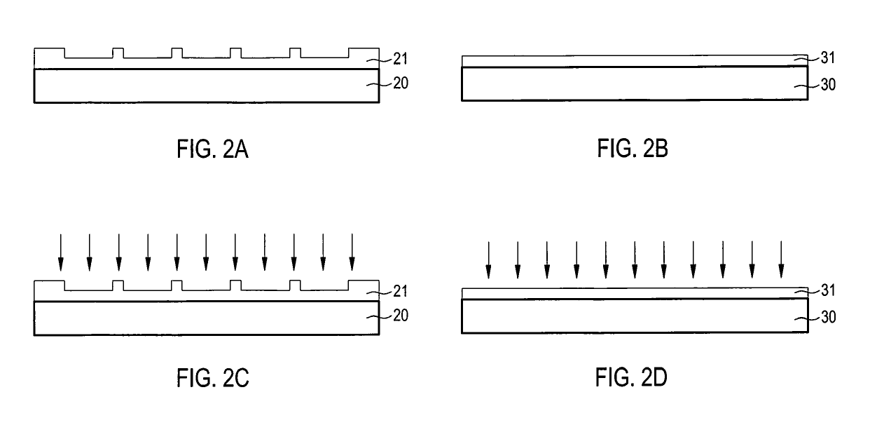

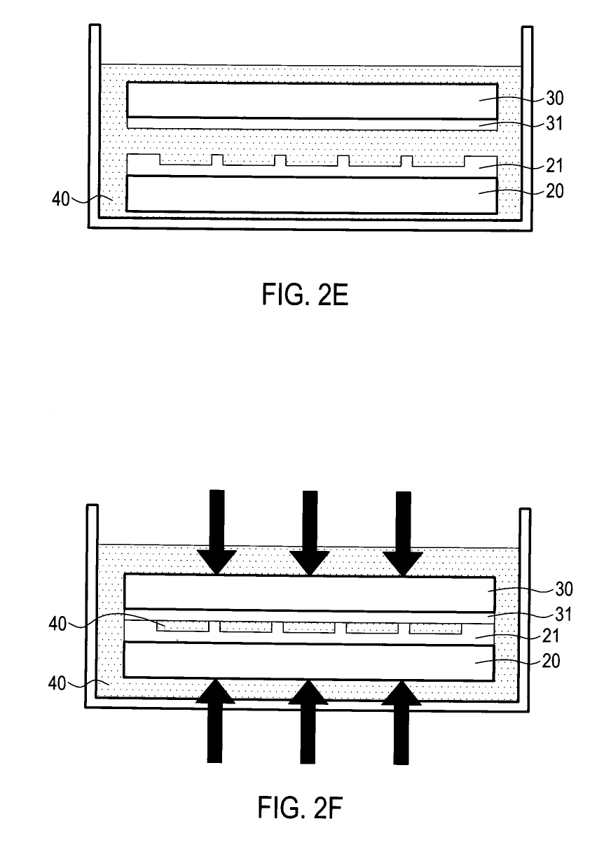

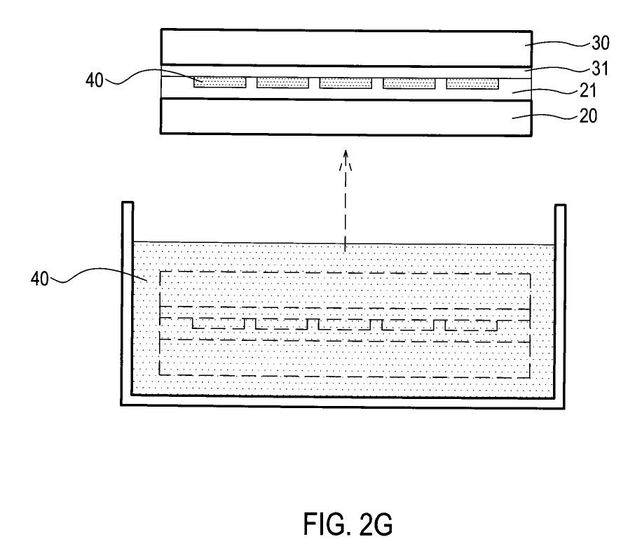

Only the structure of the display assembly 10 has been described above. The packaging method of the display assembly 10 is described below in detail with reference to FIGS. 2A to 2E.

FIGS. 2A to 2E are schematic views of a packaging method of the display assembly shown in FIG. 1. Referring to FIG. 2A, a first substrate 20 and a first protective layer 21 are provided. The first protective layer 21 is formed on a surface of the first substrate 20, totally covers the surface of the substrate 20, and has at least one concave pattern. Then, referring to FIG. 2B, a second substrate 30 and a second protective layer 31 are provided. The second protective layer 31 is formed on a surface of the second substrate 30.

The process for forming the protective layers on the substrates is the same as that in the prior art, which thus will not be described again here.

Next, referring to FIG. 2C, a plasma treatment is performed on the first protective layer 21 formed on the first substrate 20. The plasma is oxygen plasma.

Furthermore, referring to FIG. 2D, a plasma treatment is performed on the second protective layer 31 formed on the second substrate 30. The plasma is oxygen plasma.

For example, the operating conditions for the oxygen plasma treatment are described as follows: evacuating the air to 35 mtorr, and then introducing the oxygen to 75 mtorr, in which a power of an RF source is 100 W. After the oxygen plasma treatment, the PDMS surfaces are modified from a hydrophobic property into a hydrophilic property.

Next, referring to FIG. 2E, the first substrate 20 and the second substrate 30 are dipped in a water solution 40 after the plasma treatment. The water solution 40 may be an optical-coupling liquid. As the PDMS surfaces have been modified to be hydrophilic through the oxygen plasma treatment, the water solution 40 automatically covers the PDMS surface, and no bubbles will be generated during this process.

Referring to FIG. 2F, a laminating process is then performed on the first substrate 20 and the second substrate 30 in the water solution 40, and the first protective layer 21 faces the second protective layer 31 during the laminating process. The PDMS contains siloxanyl, and has advantageous optical transparency, heat resistance, and mechanical properties. When the PDMS is applied in packaging the display assembly 10, the PDMS may be used as a spacer for keeping a gap between the first substrate 20 and the second substrate 30, and the gap between the first substrate 20 and the second substrate 30 may be filled by the water solution 40.

Finally, referring to FIG. 2G, the first substrate 20 and the second substrate 30 after the laminating process are taken out of the solution. Thus, the packaging method of the display assembly is completed.

It should be noted that, the PDMS is only taken as an example of the material of the protective layers, but does not limit the present invention.

Furthermore, other packaging steps may be further included in packaging the display assembly 10, so as to improve the packaging effect. For example, after the plasma treatment, the method further includes applying an adhesive at a top of the concave pattern for enhancing the joining effect between the first protective layer 21 and the second protective layer 31. Then, after the laminating process, the method further includes adding a sealant around the joint between the first substrate 20 and the second substrate 30. Here, the sealant may be a hardened resin.

To sum up, the packaging method of the present invention is applicable to a display assembly. As the PDMS is a hydrophobic high-molecular material, after the surface treatment on the PDMS and the oxygen plasma treatment, the PDMS surface is locally defined as a hydrophilic area. Thus, a filling liquid automatically covers the PDMS surface, so as to remove the bubbles, thereby realizing the packaging effect free of bubbles.

It will be apparent to persons of ordinary art in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A bubbleless packaging method, applicable to package a display assembly, comprising:
providing a first substrate and a first protective layer, wherein the first protective layer is formed on the first substrate, totally covers the first substrate, and has at least one concave pattern;
providing a second substrate and a second protective layer, wherein the second protective layer is formed on the second substrate;
performing a plasma treatment on surfaces of the first protective layer and the second protective layer;
dipping the first substrate and the second substrate in a solution after the plasma treatment;
laminating the first substrate and the second substrate in the solution, wherein the first protective layer faces to the second protective layer; and
taking out the laminated first substrate and the second substrate from the solution.

2. The packaging method according to claim 1, wherein the water solution is an optical-coupling liquid.

3. The packaging method according to claim 1, wherein the plasma is an oxygen plasma.

4. The packaging method according to claim 1, wherein the first substrate is an indium tin oxide (ITO) glass.

5. The packaging method according to claim 1, wherein the second substrate is an indium tin oxide (ITO) glass.

6. The packaging method according to claim 1, wherein the display assembly is an electrophoretic display or a polarized display.

7. The packaging method according to claim 1, wherein the first protective layer is made of polydimethylsiloxane (PDMS) or a negative photoresist (SU8).

8. The packaging method according to claim 1, wherein the second protective layer is made of polydimethylsiloxane (PDMS) or a negative photoresist (SU8).

9. The packaging method according to claim 1, wherein the laminated first protective layer and the second protective layer are used as a spacer for keeping a gap between the first substrate and the second substrate.

10. The packaging method according to claim 1, wherein after the step of performing the plasma treatment, the packaging method further comprises a step of applying an adhesive at a top of the concave pattern.

11. The packaging method according to claim 1, wherein after the step of laminating the first substrate and the second substrate, the packaging method further comprises a step of adding a sealant around a joint between the first substrate and the second substrate.
